(19) United States
(12) Patent Application Publication
(10) Pub. No.: US 2025/0067380 A1
(43) Pub. Date: Feb. 27, 2025

(54) DAMAGED ACCELERATOR COOLING

(71) Applicant: FERMI RESEARCH ALLIANCE, LLC, Batavia, IL (US)

(72) Inventor: Abhishek Deshpande, Naperville, IL (US)

(21) Appl. No.: 18/811,043

(22) Filed: Aug. 21, 2024

Related U.S. Application Data
(60) Provisional application No. 63/578,623, filed on Aug. 24, 2023.

(51) Int. Cl. F16L 55/175; F16L 55/18; H05H 7/22; H05H 9/00

(52) U.S. Cl. CPC F16L 55/175; F16L 55/18; H05H 7/22; H05H 9/00; H05H 2242/10

(57) ABSTRACT

A system for plugging leaks includes a freeze tube configured to be inserted into a cooling line, a coolant tank, a coolant pump configured to pump coolant from the coolant tank through the freeze tube, a reservoir, an inlet pump configured to pump cooling liquid from the reservoir into the cooling line through an inlet valve, and an outlet pump configured to pump heated cooling liquid out of the cooling line through an outlet valve to the reservoir.

### CROSS-REFERENCE TO RELATED PATENT APPLICATIONS

This patent application claims the priority and benefit under 35 U.S.C. § 119 (e) of U.S. Provisional Patent Application Ser. No. 63/578,623 filed Aug. 24, 2023, entitled “DAMAGED ACCELERATOR COOLING.” U.S. Provisional Patent Application Ser. No. 63/578,623 is herein incorporated by reference in its entirety.

### STATEMENT OF GOVERNMENT RIGHTS

The invention described in this patent application was made with Government support under the Fermi Research Alliance, LLC, Contract Number DE-AC02-07CH11359 awarded by the U.S. Department of Energy. The Government has certain rights in the invention.

### TECHNICAL FIELD

The embodiments are generally related to the field of repair of damaged devices. Embodiments further relate to the field of particle accelerators. Embodiments are also related to repairs to testing devices under vacuum. Embodiments are further related to cooling schemes for LINAC bulk turners.

### BACKGROUND

Linear accelerators or “LINAC”s are a version of particle accelerator that use an oscillating potential to accelerate particles. LINACs can range from small simple devices, to highly complex large scale devices. LINACs have numerous industrial applications, including high level particle physics as well as medical applications.

LINACs require certain operational conditions to function. For example, the interior volume must be temperature controlled and the tank must be held at vacuum. In some cases, cooling lines are configured to run through the LINAC to control temperature. However, if one of those lines develops a leak, cooling fluid may leak out, compromising the integrity of the vacuum.

For some complex and/or large scale LINACs, or other such temperature controlled devices, opening the device to fix a broken cooling line might require hundreds of man hours and cost tens, or even hundreds of thousands of dollars. In other cases, it may be impossible. As a result, large scale maintenance operations are often batched so that various repairs can all be completed at once, to help mitigate the cost of repairs.

In cases where opening the LINAC is impossible, specialized tools and procedures are required to patch leaks. It may take months to complete such a repair and may be prohibitively expensive. While the leak is present, the LINAC may not be operational. The resulting downtime results in massive losses both in time and resources.

As such, there is a need in the art for systems and methods for repairing devices under vacuum with internal cooling lines, as disclosed herein.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide for leak repairs.

It is another aspect of the disclosed embodiments to provide a method for non-permanent leak repairs.

It is, another aspect of the disclosed embodiments to provide methods and systems for repairing leaks in devices held under vacuum.

It is another aspect of the disclosed embodiments to plug leaks in inaccessible cooling lines in accelerators under vacuum.

It is another aspect of the disclosed embodiments to plug leaks in inaccessible cooling lines in LINACs under vacuum.

The aforementioned aspects and other objectives and advantages can now be achieved as described herein. For example, in an embodiment a system for plugging leaks includes a freeze tube configured to be inserted into a cooling line, a coolant tank, a coolant pump configured to pump coolant from the coolant tank through the freeze tube, a reservoir, an inlet pump configured to pump cooling liquid from the reservoir into the cooling line through an inlet valve, and an outlet pump configured to pump heated cooling liquid out of the cooling line through an outlet valve to the reservoir.

In an embodiments, a system comprises a freeze tube configured to be inserted into a cooling line, a bend in the freeze tube such that an inlet of the freeze tube and outlet in the freeze tube are arranged at the same opening in the cooling line, a coolant tank, and a coolant pump configured to pump coolant from the coolant tank through the freeze tube. In an embodiment, the coolant comprises liquid nitrogen. In an embodiment, the system further comprises a plug fitted in the cooling line configured to accept the inlet of the freeze tube and the outlet of the freeze tube. In an embodiment, the freeze tube freezes liquid in the cooling line when the coolant is pumped through the freeze tube forming a freeze plug. In an embodiment, the system further comprises a cooling liquid loop configured to circulate cooling liquid in the cooling line. In an embodiment, the cooling liquid loop further comprises a reservoir, an inlet pump configured to pump cooling liquid from the reservoir to an inlet valve, and an outlet pump configured to pump cooling liquid from an outlet valve to the reservoir. In an embodiment, the system further comprises a heat exchanger configured in the reservoir. In an embodiment, the cooling line is associated with a LINAC. In an embodiment, the freeze tube is configured to be incrementally inserted further into the cooling line until a leak in the cooling line is plugged by a freeze plug.

In an embodiment a method for plugging a leak comprises inserting a freeze tube into a cooling line, filling the cooling line with cooling liquid, and pumping coolant into the freeze tube in the cooling line, thereby forming a freeze plug in the cooling line. In an embodiment, the method for plugging a leak further comprises testing the cooling line to determine if the leak is plugged, and in response to the leak not being plugged, incrementally inserting the freeze tube further into the cooling line. In an embodiment the coolant comprises liquid nitrogen. In an embodiment, the method for plugging a leak further comprises plugging an end of the cooling line with a plug configured to accept an inlet of the freeze tube and an outlet of the freeze tube. In an embodiment, the method for plugging a leak further comprises circulating a cooling liquid in the cooling line with a cooling liquid loop. In an embodiment, the method for plugging a leak further comprises pumping cooling liquid from a reservoir to an inlet valve and into the cooling line, and pumping heated cooling liquid in the cooling line through an outlet valve to a reservoir. In an embodiment, the method for plugging a leak further comprises cooling liquid in the reservoir with a heat exchanger. In an embodiment of the method, the leak comprises a leak in the cooling line of a LINAC.

In an embodiment, a system comprises a freeze tube configured to be inserted into a cooling line, a coolant tank, a coolant pump configured to pump coolant from the coolant tank through the freeze tube, a reservoir, an inlet pump configured to pump cooling liquid from the reservoir into the cooling line through an inlet valve, and an outlet pump configured to pump heated cooling liquid out of the cooling line through an outlet valve to the reservoir. In an embodiment, the system further comprises a plug fitted in an end of the cooling line configured to accept an inlet of the freeze tube and an outlet of the freeze tube. In an embodiment, the freeze tube is configured to be incrementally inserted further into the cooling line until a leak in the cooling line is plugged.

### BRIEF DESCRIPTION OF THE FIGURES

The accompanying figures, in which like reference numerals refer to identical or functionally similar elements throughout the separate views and which are incorporated in and form a part of the specification, further illustrate the embodiments and, together with the detailed description, serve to explain the embodiments disclosed herein.

FIG. 1 illustrates block diagram of a cooling line in a LINAC tank, in accordance with the disclosed embodiments;

FIG. 2 illustrates a system for plugging a leak in a cooling line, in accordance with the disclosed embodiments;

FIG. 3 illustrates a steps associated with a method for plugging a leak, in accordance with the disclosed embodiments;

FIG. 4 illustrates a method for circulating cooling liquid in a cooling line, in accordance with the disclosed embodiments; and

FIG. 5 illustrates cooling lines in a LINAC tank, in accordance with the disclosed embodiments.

### DETAILED DESCRIPTION

The particular values and configurations discussed in the following non-limiting examples can be varied, and are cited merely to illustrate one or more embodiments, and are not intended to limit the scope thereof.

Example embodiments will now be described more fully hereinafter with reference to the accompanying drawings, in which illustrative embodiments are shown. The embodiments disclosed herein can be embodied in many different forms and should not be construed as limited to the embodiments set forth herein. Rather, these embodiments are provided so that this disclosure will be thorough and complete, and will fully convey the scope of the embodiments to those skilled in the art. Like reference numerals refer to like elements throughout.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” a used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “In another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations. The principal features can be employed in various embodiments without departing from the scope disclosed herein. Those skilled in the art will recognize, or be able to ascertain, using no more than routine experimentation, numerous equivalents to the specific procedures described herein. Such equivalents are considered to be within the scope of the disclosed embodiments and are covered by the claims.

The use of the word “a” or “an” when used in conjunction with the term “comprising in the claims and/or the specification may mean “one,” but it is also consistent with the meaning of “one or more,” at “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of “having,” such as “have” and “has”), “including” (and any form of “including,” such as “includes” and “include”) or “containing” (and any form of “containing,” such as “contains” and “contain”) are inclusive or open-ended and do not exclude additional, un-recited elements or method steps.

All of the compositions and/or methods disclosed and claimed herein can be made and executed without undue experimentation in light of the present disclosure. While the compositions and methods have been described in terms of preferred embodiments, it will be apparent to those of skill in the art that variations may be applied to the compositions and/or methods and in the steps, or in the sequence of steps, of the method described herein without departing from the concept, spirit, and scope of the disclosed embodiments. All such similar substitutes and modifications apparent to those skilled in the art are deemed to be within the spirit, scope and concept as defined by the appended claims.

Embodiments are directed to cooling systems and methods, for example, with respect to a LINAC bulk tuner, or other such device, that has a damaged cooling line. During beam operations, the LINAC bulk tuner maintains the resonant frequency of a LINAC drift tube. Beam energy deposited into the bulk tuner is transferred to the cooling fluid flowing in the cooling lines which are brazed to the tuner. This arrangement is used to maintain the LINAC at constant, or very nearly constant, (usually low) temperature. In certain LINACs, the cooling lines run the entire length of the Bulk Tuner (e.g., ˜50 ft for a large LINAC). LINACs may also have several brazed joints in the cooling lines which create potential leak points.

The bulk tuner/cooling line assembly is present in vacuum. Any leaks in the cooling lines adversely affect the vacuum quality inside the LINAC. The embodiments herein, take advantage of liquid nitrogen (or other such coolants) to freeze liquid in the section of the piping that has a leak in it. Since the cooling line is a continuous loop, the other end of the line can be connected to pump(s), valving, a reservoir, and a heat exchanger. The pumps and the valves are operated in concert to provide constant exchange of cooling fluid (e.g., water) in the section of the undamaged cooling line; in effect, transferring heat from the bulk tuner. The cooling liquid is pumped against the frozen block at the other end which is maintained by a constant flow of LN₂ through small diameter tubing immersed in the frozen section.

A Proportional Integration Differential (PID) loop can be setup to maintain the frozen block at a constant temperature by varying the flow of LN₂ through the small diameter tubing. As long as the liquid under the surface of the leak point remains frozen, liquid is less likely to enter the vacuum region. Hence providing operational vacuum conditions inside the device. In some cases, this can be a non-permanent solution until a permanent fix is scheduled for the leaking cooling line, for example at a time when batched repair operations are schedule to fix multiple items at once.

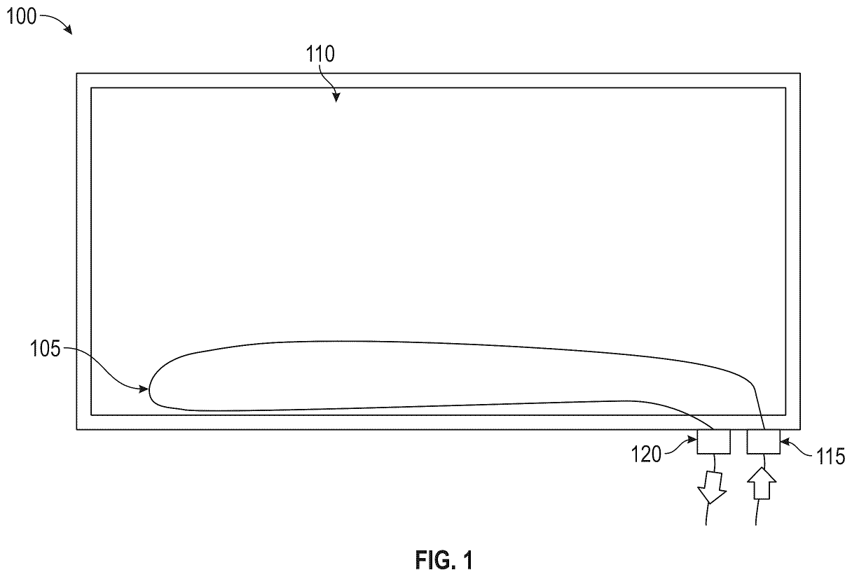

FIG. 1 illustrates a schematic diagram of a device 100 with internal cooling lines 105. In certain embodiments, the device 100 can comprise a tank associated with a LINAC bulk tuner, but in other embodiments, the device 100 can comprise any device with cooling lines, and in particular a device with the internal volume 110 held under vacuum with an internal cooling line (or lines) 105. The internal cooling line 105 is generally configured with an inlet 115 and outlet 120, external to the device 100, so that cooling liquid can be pumped through the cooling line 105.

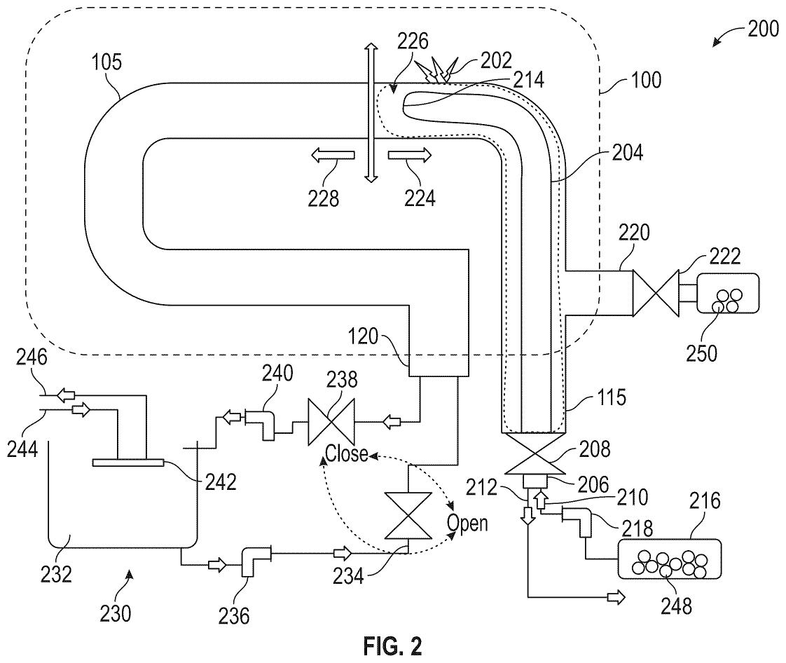

FIG. 2 illustrates a system 200 for stopping a leak 202 in a cooling line 105 of a device 100 in accordance with the disclosed embodiments. Freeze tubing 204 can be inserted through a plug 206 in a valve 208 of the cooling line 105. In an exemplary embodiment, the freeze tubing 204 can comprise ⅛ inch 316 stainless steel tubing configured to carry liquid nitrogen (or other such coolant). In other embodiments, the freeze tubing 204 can be appropriately selected in size and material for the intended application.

As illustrated, the freeze tubing 204 can be inserted into the cooling line 105. The system can include an input 210 to the freeze tubing 204 and return 212 of the freeze tubing 204, such that a return bend 214 extends at or near the leak 202 in the cooling line 105. It should be appreciated that the diameter of the freeze tubing 204 can be selected to be less than half the diameter of the cooling line 105, such that the freeze tubing input and return can be located proximately at an end of the cooling line 105, where the freeze tubing flow path runs in an open loop inside the desired segment of the cooling line 105. In some embodiments, the bend 214 in the freeze tube 204 is configured such that an inlet of the freeze tube 204 and outlet in the freeze tube 204 are arranged at the same opening or stub out in the cooling line 105.

The input 210 can generally be connected to a freeze dewar 216 by a pump 218. The freeze dewar 216 can comprise cryogenic storage vessel equipped for storage of, for example, liquid nitrogen. The freeze dewar 216 can be configured to reduce the risk of pressure buildup from gas as the liquid nitrogen boils away.

The pump 218 is used to pump a coolant such as liquid nitrogen (or other such compound capable of freezing liquid in the cooling line 105) from the freeze dewar 216. The liquid nitrogen can be pumped through the input 210 into the cooling line 105 in the freeze tubing 204, and circulated to the return 212.

In certain embodiments, this can comprise a Proportional Integration Differential (PID) loop. In such embodiments, a PID controller can be used to read a sensor indicative of temperature and/or a senor indicating flow rate, and then determine the required flow rate and/or coolant temperature to maintain the required freeze plug 226 in the cooling line 105. The PID loop can use proportional, integral, and derivative responses, to identify the required flow rate and/or coolant temperature.

In some embodiments, a stub out 220 and associated valve 222 can be provided on the cooling line 105. The valve 222 is a liquid fill valve for adding liquid to the cooling line 105. The stub out 220 and valve 222 can therefore be used to add or remove coolant from the cooling line as necessary.

Once a leak is detected, the freeze tubing 204 can be inserted into the cooling line 105, and liquid 250 (for example water) can be added to the cooling line 105. In certain embodiments the liquid 250 can be added to the cooling line 105 via the stub out 220 and associated valve 222. In some embodiments, it may be necessary to first remove other coolant from the line, before adding additional liquid 250.

Coolant 248, which can be liquid nitrogen, can then be pumped through the freeze tubing 204, freezing the liquid in the cooling line 105. Arrow 224 illustrates the section of the cooling line 105 with frozen liquid forming a freeze plug 226. The freeze plug 226 can comprise an in-situ frozen crystalline structure formed in the cooling line. In certain embodiments the freeze plug 226 can comprise ice, however, more generally the freeze plug 226 can be any frozen liquid. It should be appreciated that the freezing point of the liquid 250 must be higher than the freezing point of the coolant 248, so that the coolant 248, can flow through the freeze tubing 204 and cool the liquid 250 to a temperature that is lower than its freeze point.

Arrow 228 illustrates the section of the cooling line 105, where cooling liquid 250 remains liquid. The freeze plug 226 formed by the frozen liquid in the cooling line 105 prevents liquid 250 from exiting the leak 202, and maintains the operational integrity of the vacuum in the vessel 100.

Once the freeze plug 226 is established, the cooling line 105 can still provide adequate cooling to the device 100. In some embodiments, this can be accomplished with a cooling liquid loop 230, which can be established at another input or output associated with the cooling line, for example at the opposing end of the cooling line 105.

FIG. 2 illustrates additional aspects of the system 200 which can include the cooling loop 230. In an embodiment, a cooling liquid reservoir 232 can be operably connected to an inlet valve 234 via inlet pump 236. The cooling liquid reservoir 232 can also be operably connected to an outlet valve 238 by outlet pump 240.

An immersion heat exchanger 242 can be disposed in the cooling liquid reservoir 232, with a cold liquid supply 244 and a cold liquid return 246, used to keep the liquid in the cooling liquid reservoir 232 cold. It should be appreciated that in some embodiments, the cooling liquid can be water, but more generally, the cooling liquid can comprise other liquid coolants.

Cold water (or other cooling liquid) from the cooling liquid reservoir 232 can be pumped in a cycle into, and out of, the cooling line 105 in order to control the temperature of the device 100. When the inlet valve 234 is open the outlet valve 238 is closed, allowing cooling liquid to flow into the cooling line 105. Heat from the device 100 is transferred to the cooling liquid in the cooling line 105, at which point the outlet valve 238 is opened and the inlet valve 234 is closed so that the heated cooling liquid can be pumped out of the cooling line 105 into the cooling liquid reservoir 232. The process can be completed at a sufficiently rapid interval to ensure the device 100 is maintained at a desirable temperature.

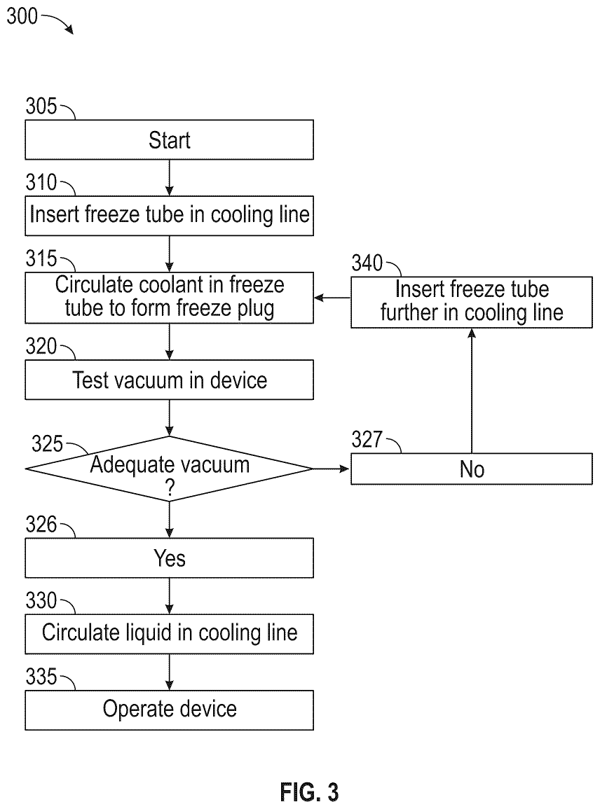

FIG. 3 illustrates a method 300 for plugging a leak, using the systems, such as system 200, disclosed herein. The method starts at 305. If a leak is suspected in the cooling line (often as a result of a loss of vacuum in the device), at step 310, a freeze tube 204 can be inserted into a cooling line 105. The freeze tube 204 is configured with a bend such that the inlet and outlet of the freeze tube 204 can extend outside the cooling line. The relative location of the bend in the freeze tube 204, defines the furthest penetration point of the freeze tube 204 in the cooling line 105. In certain embodiments, the freeze tube 204 can comprise ⅛ inch welded stainless steel tubing, but other materials and sizes are possible.

An aspect of the present embodiments is to maintain, to the greatest degree possible, liquid flow in the cooling line. As such, the freeze tube bend can be inserted into the cooling line 105 a relatively short distance from the cooling line stub out.

If the cooling line 105 is not already filled, it can be flooded with cooling liquid 250. At step 315, coolant 248, which can comprise liquid nitrogen or other such coolants, can be circulated through the freeze tube 204 in order to form a freeze plug 226.

With the freeze plug 226 in place, the vacuum in the device 100 can be tested at step 320. If vacuum can be drawn in the device 100 to the tolerance necessary, as shown by “YES” block 326 following decision block 325, cooling fluid can be circulated in the cooling line at 330, and the device can be operated at 335. It should be appreciated that the operation of the device can include use of a cooling loop 230, to pump coolant into the cooling line 105 against the freeze plug 226, and then to replace that coolant after it has absorbed heat from the device 100, as further detailed herein.

If adequate vacuum has not been achieved, as shown by “NO” block 327 following decision block 325, the coolant in the freeze tube 204 can optionally be drained, and the freeze tube 204 can be inserted further into the cooling line 105 at step 340. The freeze plug 226 can then be reestablished by circulating coolant 248 through the freeze tube 204. This process can be iterated, incrementally increasing the penetration depth of the freeze tube 204, until the desired vacuum is achieved. This approach minimizes the penetration depth of the freeze tube 204, and maximizes the volume of cooling liquid that can be provided in the cooling tube 105.

Once the freeze plug 226 location has been iteratively determined, and the freeze plug 226 is set, it is necessary to circulate cooling liquid (usually water, although other liquids can be used) in the cooling line 105, to control the temperature of the device 100 during operation. However, the cooling line 105 is configured as a loop, where cooling liquid can be circulated in through the inlet and out the outlet. With the outlet (or inlet) blocked with the freeze plug, the cooling liquid must be provided in a different way.

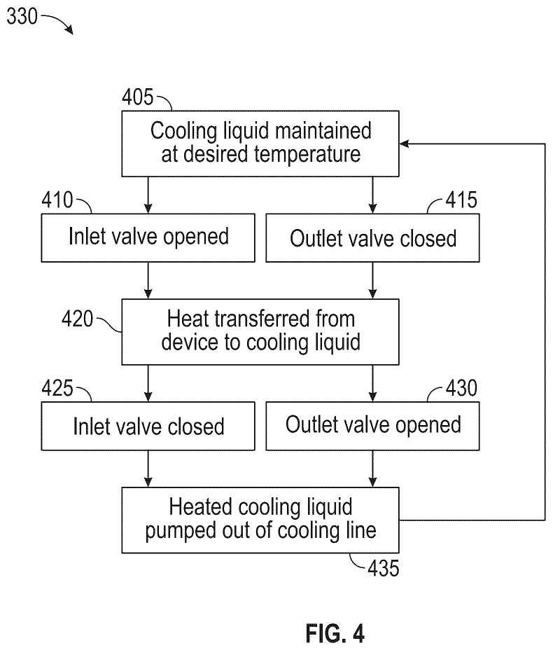

FIG. 4 illustrates one method for circulating liquid in the cooling line with the cooling loop 230, as illustrated in step 330 of FIG. 3. In this method, the liquid in the reservoir can be maintained at the desired temperature, as shown at step 405. An immersion heat exchanger 242 can be used to maintain the temperature in the reservoir 232, which can also be fitted with a cold water supply 244 and cold water return 246.

In certain embodiments, the inlet pump 236 and outlet pump 240 can be configured to provide pressure to the service lines between the reservoir 232 and cooling line 105. In other embodiments, the pumps can be turned on and off in synch with the respective inlet 234 and outlet 238 valves.

Next, at step 410 the inlet valve 234 can be opened, and at step 415 the outlet valve 238 can substantially simultaneously be closed. The cooling liquid can thus be pumped into the cooling line 105 against freeze plug 226. At step 420 heat from the device 100 is transferred to the liquid in the cooling line 105.

At step 425, the inlet valve 234 can be closed, and at step 430 the outlet valve 238 can substantially simultaneously be opened. The heated cooling liquid can thus be pumped out of the cooling line 105 with outlet pump and back to the reservoir 232 at step 435.

The process then cycles back to steps 410 and 415. The cycle duration can be selected to ensure the cooling line provides sufficient heat transfer out of the device 100 to maintain the desired temperature. In some cases, the cycle time will depend on the location of the leak 202, since a leak closer to the middle of the cooling line 105 will require a longer freeze plug 226, and will provide less cooling volume in the cooling line 105 after the freeze plug 226 is established. By contrast, a leak near the inlet 115 or outlet 120 of the cooling line 105 will require a shorter freeze plug 226 and will provide more cooling volume in the cooling line 105 after repair.

It should be appreciated that in certain embodiments, the device 100 can comprise a LINAC with a bulk tuner. In other embodiments, the device 100 can comprise any system with integrated cooling lines. In certain implementations, the cooling lines may be located in a place that is inaccessible for repair, including but not limited to, internal to a chamber under vacuum.

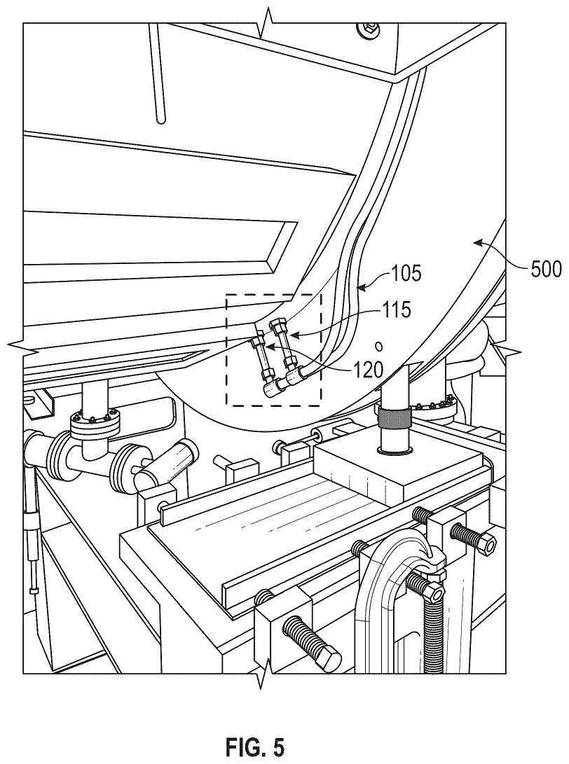

FIG. 5 illustrates an exemplary LINAC with a LINAC tank and bulk tuner cooling lines. The methods and systems disclosed herein can be applied to or with a LINAC 500 as illustrated in FIG. 5. FIG. 5 further illustrates exemplary cooling lines 105, with an inlet 115 and outlet 120.

While the embodiments disclosed herein may be applied to the bulk tuner of a LINAC, it should be understood that the methods and systems may be applied to any cooling line where access to a leak in the line is difficult.

Based on the foregoing, it can be appreciated that a number of embodiments are disclosed herein. In an embodiments, a system comprises a freeze tube configured to be inserted into a cooling line, a bend in the freeze tube such that an inlet of the freeze tube and outlet in the freeze tube are arranged at the same opening in the cooling line, a coolant tank, and a coolant pump configured to pump coolant from the coolant tank through the freeze tube. In an embodiment, the coolant comprises liquid nitrogen. In an embodiment, the system further comprises a plug fitted in the cooling line configured to accept the inlet of the freeze tube and the outlet of the freeze tube. In an embodiment, the freeze tube freezes liquid in the cooling line when the coolant is pumped through the freeze tube forming a freeze plug. In an embodiment, the system further comprises a cooling liquid loop configured to circulate cooling liquid in the cooling line. In an embodiment, the cooling liquid loop further comprises a reservoir, an inlet pump configured to pump cooling liquid from the reservoir to an inlet valve, and an outlet pump configured to pump cooling liquid from an outlet valve to the reservoir. In an embodiment, the system further comprises a heat exchanger configured in the reservoir. In an embodiment, the cooling line is associated with a LINAC. In an embodiment, the freeze tube is configured to be incrementally inserted further into the cooling line until a leak in the cooling line is plugged by a freeze plug.

In an embodiment a method for plugging a leak comprises inserting a freeze tube into a cooling line, filling the cooling line with cooling liquid, and pumping coolant into the freeze tube in the cooling line, thereby forming a freeze plug in the cooling line. In an embodiment, the method for plugging a leak further comprises testing the cooling line to determine if the leak is plugged, and in response to the leak not being plugged, incrementally inserting the freeze tube further into the cooling line. In an embodiment the coolant comprises liquid nitrogen. In an embodiment, the method for plugging a leak further comprises plugging an end of the cooling line with a plug configured to accept an inlet of the freeze tube and an outlet of the freeze tube. In an embodiment, the method for plugging a leak further comprises circulating a cooling liquid in the cooling line with a cooling liquid loop. In an embodiment, the method for plugging a leak further comprises pumping cooling liquid from a reservoir to an inlet valve and into the cooling line, and pumping heated cooling liquid in the cooling line through an outlet valve to a reservoir. In an embodiment, the method for plugging a leak further comprises cooling liquid in the reservoir with a heat exchanger. In an embodiment of the method, the leak comprises a leak in the cooling line of a LINAC.

In an embodiment, a system comprises a freeze tube configured to be inserted into a cooling line, a coolant tank, a coolant pump configured to pump coolant from the coolant tank through the freeze tube, a reservoir, an inlet pump configured to pump cooling liquid from the reservoir into the cooling line through an inlet valve, and an outlet pump configured to pump heated cooling liquid out of the cooling line through an outlet valve to the reservoir. In an embodiment, the system further comprises a plug fitted in an end of the cooling line configured to accept an inlet of the freeze tube and an outlet of the freeze tube. In an embodiment, the freeze tube is configured to be incrementally inserted further into the cooling line until a leak in the cooling line is plugged.

It will be appreciated that variations of the above-disclosed and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the following claims.

What is claimed is:

1. A system comprising:
a freeze tube configured to be inserted into a cooling line;
a bend in the freeze tube such that an inlet of the freeze tube and outlet in the freeze tube are arranged at the same opening in the cooling line;
a coolant tank; and
a coolant pump configured to pump coolant from the coolant tank through the freeze tube.

2. The system of claim 1 wherein the coolant comprises liquid nitrogen.

3. The system of claim 1 further comprising:
a plug fitted in the cooling line configured to accept the inlet of the freeze tube and the outlet of the freeze tube.

4. The system of claim 1 wherein the freeze tube freezes liquid in the cooling line when the coolant is pumped through the freeze tube forming a freeze plug.

5. The system of claim 1 further comprising:
a cooling liquid loop configured to circulate cooling liquid in the cooling line.

6. The system of claim 5 wherein the cooling liquid loop further comprises:
a reservoir;
an inlet pump configured to pump cooling liquid from the reservoir to an inlet valve; and
an outlet pump configured to pump cooling liquid from an outlet valve to the reservoir.

7. The system of claim 6 further comprising:
a heat exchanger configured in the reservoir.

8. The system of claim 1 wherein the cooling line is associated with a LINAC.

9. The system of claim 1 wherein the freeze tube is configured to be incrementally inserted further into the cooling line until a leak in the cooling line is plugged by a freeze plug.

10. A method for plugging a leak comprising:
inserting a freeze tube into a cooling line;
filling the cooling line with cooling liquid; and
pumping coolant into the freeze tube in the cooling line, thereby forming a freeze plug in the cooling line.

11. The method for plugging a leak of claim 10 further comprising:
testing the cooling line to determine if the leak is plugged; and
in response to the leak not being plugged, incrementally inserting the freeze tube further into the cooling line.

12. The method for plugging a leak of claim 10 wherein the coolant comprises liquid nitrogen.

13. The method for plugging a leak of claim 10 further comprising:
plugging an end of the cooling line with a plug configured to accept an inlet of the freeze tube and an outlet of the freeze tube.

14. The method for plugging a leak of claim 10 further comprising:
circulating a cooling liquid in the cooling line with a cooling liquid loop.

15. The method for plugging a leak of claim 14 further comprising:
pumping cooling liquid from a reservoir to an inlet valve and into the cooling line; and
pumping heated cooling liquid in the cooling line through an outlet valve to the reservoir.

16. The method for plugging a leak of claim 15 further comprising:
cooling the cooling liquid in the reservoir with a heat exchanger.

17. The method for plugging a leak of claim 10, wherein the leak comprises a leak in the cooling line of a LINAC.

18. A system comprising:
a freeze tube configured to be inserted into a cooling line;
a coolant tank;
a coolant pump configured to pump coolant from the coolant tank through the freeze tube;
a reservoir;
an inlet pump configured to pump cooling liquid from the reservoir into the cooling line through an inlet valve; and
an outlet pump configured to pump heated cooling liquid out of the cooling line through an outlet valve to the reservoir.

19. The system of claim 18 further comprising:
a plug fitted in an end of the cooling line configured to accept an inlet of the freeze tube and an outlet of the freeze tube.

20. The system of claim 18 wherein the freeze tube is configured to be incrementally inserted further into the cooling line until a leak in the cooling line is plugged.
